(19) United States
(12) Patent Application Publication
(10) Pub. No.: US 2014/0126501 A1
(43) Pub. Date: May 8, 2014

(54) METHOD AND DEVICE FOR INTER-CELL INTERFERENCE COORDINATION

(71) Applicants: Xueming Pan, Beijing (CN); Jing Xu, Beijing (CN); Zukang Shen, Beijing (CN)

(72) Inventors: Xueming Pan, Beijing (CN); Jing Xu, Beijing (CN); Zukang Shen, Beijing (CN)

(73) Assignee: China Academy of Telecommunications Technology, Beijing (CN)

(21) Appl. No.: 14/111,180

(22) PCT Filed: Mar. 19, 2012
(86) PCT No.: PCT/CN2012/072513

§ 371 Date: Nov. 7, 2013

(30) Foreign Application Priority Data
Apr. 8, 2011 (CN) 201110088347.2

(51) Int. Cl. H04L 5/00; H04W 88/08

(52) U.S. Cl. CPC H04L 5/0032; H04W 88/08
USPC 370/329

(57) ABSTRACT

The present invention provides a method and a device for inter-cell interference coordination. The method comprises: acquiring sub-frame configuration information of neighbor cells; determining whether the neighbor cells are configured with transmissions in different directions on the same sub-frame; and if yes, performing interference coordination between the neighbor cells according to acquired data transmission-related information of the neighbor cells on the same sub-frame. Through the present invention, neighbor TDD base station cells are enabled to perform transmissions in different directions on the same time resource, interference is avoided through the interference coordination, and the situation in the conventional TDD interference coordination method that different cells are forced to use the same sub-frame configuration and cannot adapt to service requirements of the cells is avoided.

The present application claims priority to Chinese Patent Application No. 201110088347.2, filed with the State Intellectual Property Office of China on Apr. 8, 2011 and entitled “Method and device for inter-cell interference coordination”, which is hereby incorporated by reference in its entirety.

### FIELD OF THE INVENTION

The present invention relates to the field of wireless communication technologies and particularly to a method and a device for inter-cell interference coordination.

### BACKGROUND OF THE INVENTION

For general duplex modes adopted by a cellular system, as illustrated in FIG. 1, the Time Division Duplex (TDD) mode refers to transmission of uplink and downlink signals in the uplink and the downlink in the same operating frequency band in different time interval with a guard period between the uplink and the downlink; and the Frequency Division Duplex (FDD) mode refers to transmission of uplink and downlink signals in the uplink and the downlink in different operating frequency bands over different frequency carriers at the same time with a guard band between the uplink and the downlink.

There is a somewhat complex frame structure of a Time Division-Long Term Evolution (TD-LTE) system, as illustrated in FIG. 2, where a radio frame has a length of 10 ms and includes 10 sub-frames including a special sub-frame and normal sub-frames, each of the sub-frames is 1 ms. The special sub-frame includes 3 timeslots: a DwPTS for transmission of a Packet Switched Service (PSS)/a Physical Downlink Control Channel (PDCCH)/a Physical HARQ Indicator Channel (PHICH)/a Physical Control Format Indicator Channel (PCFICH)/a Physical Downlink Shared Channel (PDSCH), etc.; a GP functioning as a guard period between the uplink and the downlink; and an UpPTS for transmission of a Sounding Reference Symbol (SRS)/a Physical Random Access Channel (PRACH). The normal sub-frames include uplink sub-frames and downlink sub-frames for transmission uplink and downlink control signalling, service data, etc. Two special sub-frames (sub-frames #1 and #6) can be configured or one special sub-frame (a sub-frame #1) can be configured in one radio frame. A sub-frame #0 and a sub-frame #5 and the DwPTS in the special sub-frame are always used for downlink transmission, a sub-frame #2 and the UpPTS in the special sub-frame are always used for uplink transmission, and the other sub-frames can be configured for uplink transmission or downlink transmission as needed.

In the TD-LTE system, the three timeslots DwPTS/GP/UpPTS in the special sub-frame are 1 ms in total, and the three timeslots are assigned in length to support different configuration conditions, as depicted in Table 1, where the time is in a length unit of Tₛ, and 1Tₛ=1/(15000×2048) second.

TABLE 1
Configuration Format of a TD-LTE Special Sub-frame

| | Normal CP | | | Extended CP | | |
|---|---|---|---|---|---|---|
| Configuration No. | DwPTS | GP | UpPTS | DwPTS | GP | UpPTS |
| 0 | 6592 · Tₛ | 21936 · Tₛ | 2192 · Tₛ | 7680 · Tₛ | 20480 · Tₛ | 2560 · Tₛ |
| 1 | 19760 · Tₛ | 8768 · Tₛ | | 20480 · Tₛ | 7680 · Tₛ | |
| 2 | 21952 · Tₛ | 6576 · Tₛ | | 23040 · Tₛ | 5120 · Tₛ | |
| 3 | 24144 · Tₛ | 4384 · Tₛ | | 25600 · Tₛ | 2560 · Tₛ | |
| 4 | 26336 · Tₛ | 2192 · Tₛ | | 7680 · Tₛ | 17920 · Tₛ | 5120 · Tₛ |
| 5 | 6592 · Tₛ | 19744 · Tₛ | 4384 · Tₛ | 20480 · Tₛ | 5120 · Tₛ | |
| 6 | 19760 · Tₛ | 6576 · Tₛ | | 23040 · Tₛ | 2560 · Tₛ | |
| 7 | 21952 · Tₛ | 4384 · Tₛ | | — | — | — |
| 8 | 24144 · Tₛ | 2192 · Tₛ | | — | | — |

In the TD-LTE system, there are 7 supported allocation schemes of the uplink and downlink sub-frames, and configuration parameters are as depicted in Table 2, where D represents downlink transmission, U represents uplink transmission, and S represents that the sub-frame is a special sub-frame including three sections of DwPTS, GP and UpPTS.

TABLE 2
Configuration Format of TD-LTE
Uplink and Downlink Sub-frames

| Configur- | | | | | | | | | | | |
|---|---|---|---|---|---|---|---|---|---|---|---|
| ation | Switching | Sub-frame No. | | | | | | | | | |
| No. | Period | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

The foregoing configuration of the special sub-frame and configuration schemes of the uplink and downlink sub-frames are broadcasted to all of users in a cell in System Information (SI).

As can be apparent, a change to the foregoing two frame configuration parameters through a System Information Change is supported in the TD-LTE standard, but this change further needs procedures of paging, newly reading system information, etc., and there are several ambiguous issues before and after the change, for example, resulting in an adverse influence on Hybrid Automatic Repeat Request (HARQ) operation and scheduling, etc. If the frame configurations are changed frequently, then the performance of the system will be seriously degraded. Moreover, there is a minimum frame configuration change period of 640 ms supported in the TD-LTE standard, and this cannot accommodate a dynamically changing requirement of a service.

In view of this, there is a dynamic uplink and downlink sub-frame allocation solution proposed in the prior art, but in this dynamic TDD sub-frame configuration solution, if different uplink and downlink sub-frames configurations are set for different cells, as illustrated in FIG. 3, then cross-timeslot interference of neighbor cells will arise, and such interference includes interference of neighbor cells at the same frequency and interference of neighbor cells at adjacent frequencies. If such interference fails to be addressed, then the benefit of a dynamic configuration of the uplink-to-downlink ratio cannot be gained, and on the contrary, the entire network will be broken down. It shall be noted that the neighbor cells here can be geographically neighbor cells over the same TDD carrier (as illustrated in FIG. 3). Also the cells as referred here to can be cells deployed at the same layer (e.g., macro cells) or can be cells deployed across different layers (e.g., a macro cell, a femto cell, a home base station, etc.)

A traditional method for avoiding TDD cross-timeslot interference is the use of sub-frame coordination, where the current cell cannot use a sub-frame for downlink transmission when it is known that the sub-frame is used by a neighbor cell for uplink transmission, that is, the current cell sets the sub-frame to be an uplink sub-frame or idle. Since there are different service conditions in respective cells, this traditional method poses a significant restraint on the operation of a real network in that the respective cells cannot select their sub-frame configuration schemes according to their own real-time service conditions, thus lowering the utilization of system resources of the TDD network.

### SUMMARY OF THE INVENTION

The embodiments of the invention provides a method and a device for inter-cell interference coordination so as to perform transmissions in neighbor cells in different directions over the same time resource without any interference between the neighbor cells.

An embodiment of the invention provides a method for inter-cell interference coordination, the method including:
obtaining sub-frame configuration information of neighbor cells and determining whether the neighbor cells are configured with transmissions in different directions in the same sub-frame; and
if so, then performing interference coordination between the neighbor cells according to obtained data transmission related information of the neighbor cells in the same sub-frame.

An embodiment of the invention further provides a device for inter-cell interference coordination, the device including:
a judging unit configured to obtain sub-frame configuration information of neighbor cells and to judge whether the neighbor cells are configured with transmissions in different directions in the same sub-frame, and
an interference coordinating unit configured to perform interference coordination between the neighbor cells according to obtained data transmission related information.

An embodiment of the invention further provides a base station including:
a sub-frame configuration obtaining unit configured to obtain sub-frame configuration information of neighbor cells; and
a coordinating unit configured to adjust a resource used by a cell located in the base station among the neighbor cells to perform interference coordination between the neighbor cells according to obtained data transmission related information of the neighbor cells in the same sub-frame upon determining that the neighbor cells are configured with transmissions in different directions in the same sub-frame.

With the method and device for inter-cell interference coordination according to the embodiments of the invention, there are the following advantageous effects: transmissions can be performed in neighbor TDD base station cells over the same time resource in different directions, and mutual interference can be avoided through interference coordination: and such a situation in the traditional TDD interference coordination method can be obviated that different cells are forced to use the same sub-frame configuration so that service demands of the respective cells can not be accommodated. The method of the embodiment of the invention can be applicable to such situations that neighbor TDD cells operate over the same operating carriers as well as adjacent operating carriers.

### BRIEF DESCRIPTION OF THE DRAWINGS

FIG. 1 is a schematic diagram of the time and frequency relationships in the fundamental duplex modes in the prior art;

FIG. 2 is a schematic diagram of a frame structure in a TD-LTE system in the prior art;

FIG. 3 is a schematic diagram of TDD cross-timeslot interference in the prior art;

FIG. 4 is a flow chart of a method for inter-cell interference coordination according to an embodiment of the invention;

FIG. 5 is a schematic diagram of neighbor cells with frequency division transmission of signals in different directions in the same sub-frame according to an embodiment of the invention;

FIG. 6 is a schematic diagram of a dynamic uplink and downlink sub-frame allocation solution according to an embodiment of the invention;

FIG. 7 is a structural diagram of a device for inter-cell interference coordination according to an embodiment of the invention; and

FIG. 8 is a schematic structural diagram of a base station according to an embodiment of the invention.

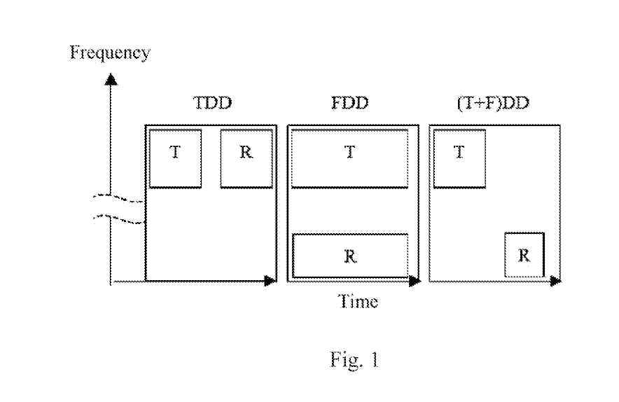

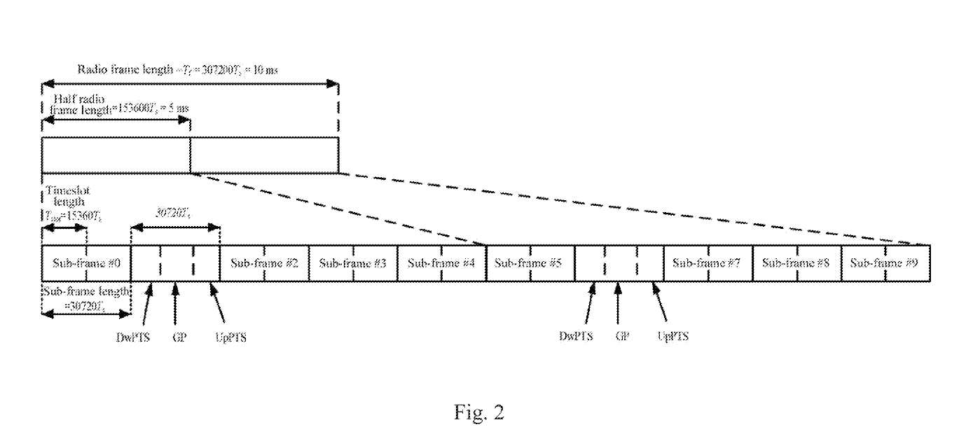

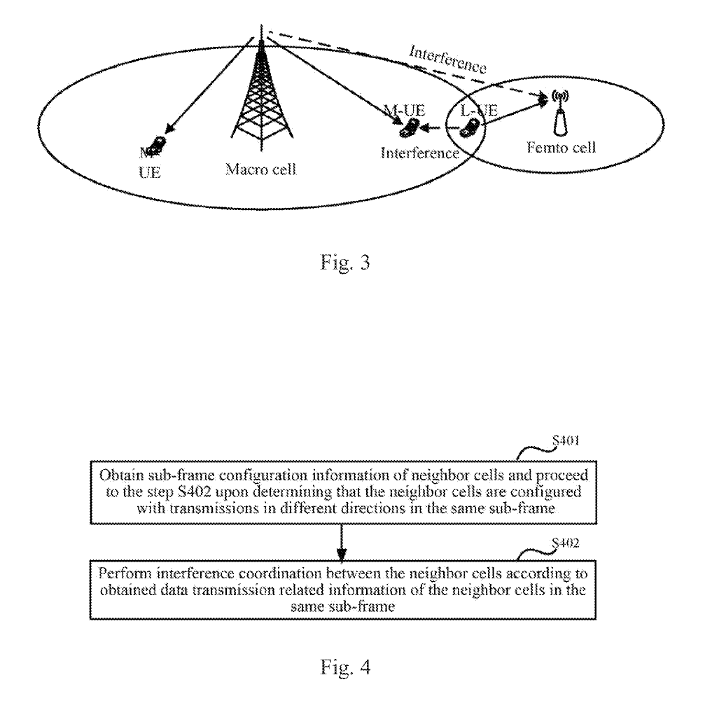

### DETAILED DESCRIPTION OF THE EMBODIMENTS

A method and a device for inter-cell interference coordination according to embodiments of the invention will be described below in further details with reference to the drawings and the embodiments.

The TDD mode which is one of the two fundamental duplex modes has gained increasing attention in the context of a constantly increasing bandwidth demand of broadband mobile communications. For both uplink and downlink transmissions in a TDD system, uplink and downlink signals are transmitted over the same frequency resource in different timeslots. In common TDD systems including a 3G Time Division-Synchronous Code Division Multiple Access (TD-SCDMA) system and a 4G TD-LTE system, uplink and downlink timeslots are allocated statically or semi-statically, and a common method is to determine the ratio of allocated uplink to downlink timeslots dependent on the type and the rough service ratio of a cell and to keep the ratio unchanged. This is a simple method and also effective in the context of a macro cell with large coverage. Along with the technical development, an increasing number of low-power base stations including pico cells, home NodeBs, etc., are deployed to provide small local coverage, and in these cells, there are a small number of users and a significantly varying service demand of the users, so there is a dynamically changing demand for an uplink-to-downlink service ratio of the cells. Although an online change to the uplink-to-downlink timeslot ratio of a cell is also supported, for example, in the TD-LTE standard, a complex signalling flow and a configuration time period are required, thus degrading the performance of the system and also failing to trace a real time service change condition.

In view of this, some more dynamic TDD uplink and downlink configuration solutions have gained attention, but an application obstacle to these solutions is to arise serious cross-timeslot interference between neighbor cells, and such interference includes interference of neighbor cells at the same frequency and interference of neighbor cells at adjacent frequencies. If such interference fails to be addressed, then the benefit of a dynamic configuration of the uplink-to-downlink ratio cannot be gained, and on the contrary, the entire network will be broken down. An embodiment of the invention proposes a method for inter-cell interference coordination, preferably applicable to a Time Division-Long Term Evolution (TD-LTE) system, where neighbor TDD cells in the same network are temporally synchronized, and sub-frame configuration conditions of neighbor cells can be identified accurately and related interference avoidance operations are supported in the embodiment of the invention. As illustrated in FIG. 4, the method includes the following steps.

The step S401 is to obtain sub-frame configuration information of neighbor cells and to proceed to the step S402 upon determining that the neighbor cells are configured with transmissions in different directions in the same sub-frame.

In the method according to the embodiment of the invention, the neighbor cells can be geographically neighbor cells over the same TDD carrier. Also the neighbor cells here can be cells deployed at the same layer (e.g., macro cells) or can be cells deployed across different layers (e.g., a macro cell, a femto cell, a home base station, etc.). Thus the foregoing neighbor cells may be located at the same base station or different base stations, and in the latter case, the neighbor cells perform interaction of the frequency domain resource use information in the same sub-frame through signalling interaction between the different base stations.

The sub-frame configuration information in the embodiment of the invention includes locations of respective uplink sub-frames and locations of respective downlink sub-frames in a radio frame.

The step S402 is to perform interference coordination between the neighbor cells according to obtained data transmission related information of the neighbor cells in the same sub-frame.

In the prior art with the dynamic uplink and downlink sub-frame allocation solution, only a service demand is considered without taking into account whether uplink and downlink data transmissions are configured in the same sub-frame for the neighbor cells and even data transmission related information of the same sub-frame configured with uplink and downlink transmissions, thus easily resulting in cross-timeslot interference, and in the method according to the embodiment of the invention, data transmission related information in the same sub-frame configured with uplink and downlink transmissions in the neighbor cells is obtained to support judgment of whether there will be inter-cell interference arising, and interference coordination between the neighbor cells is performed according to the data transmission related information, thereby avoiding cross-timeslot interference in the dynamic uplink and downlink sub-frame allocation scenario so as to perform transmissions in neighbor TDD base station cells in different directions over the same time resource.

Preferably, if the neighbor cells are not configured with transmissions in different directions in the same sub-frame, then an existing flow proceeds.

Preferably, an executor for inter-cell interference coordination is a base station or a higher-layer network node of a base station, and when the executor is a base station, the base station adjusts a resource used by a cell located in the base station among the neighbor cells to perform interference coordination between the neighbor cells. If the executor is a higher-layer network node of a base station, interference coordination between the neighbor cells can be performed regardless of whether the neighbor cells are located at different base stations.

The data transmission related information can be parameter information that can be provided to a base station to perform interference judgment, and preferably in the embodiment of the invention, the data transmission related information can include frequency domain resource use information, and the base station obtains the frequency domain resource use information of the neighbor cells in the same sub-frame, to obtain frequency domain resource occupancy conditions of the neighbor cells in the same sub-frame; and performs interference coordination between the cell and the neighbor cell through frequency domain resource coordination according to the obtained frequency domain resource use information.

Typically if the neighbor cells configured with uplink and downlink transmissions use frequency domain resources over the same operating carrier in the same sub-frame or use frequency domain resources over adjacent operating carriers in the same sub-frame, inter-cell interference will arise, and in this embodiment, interference coordination between the neighbor cells is performed through frequency domain resource coordination, which includes: the frequency domain resources used by the neighbor cells in the same sub-frame are adjusted to avoid the neighbor cells from using the same frequency domain resource in the same sub-frame. For example, when the neighbor cells are determined to use the same frequency domain resource in the same sub-frame, the frequency domain resource used by the neighbor cells in the same sub-frame is adjusted to avoid the neighbor cells from using the same frequency domain resource in the same sub-frame, thus avoiding interference between the neighbor cells over the same carrier from arising in the same sub-frame configured with uplink and downlink transmissions.

When the neighbor cells are determined to respectively use adjacent frequency domain resources over adjacent carriers in the same sub-frame, the frequency domain resources used by the neighbor cells in the same sub-frame are adjusted to avoid the adjacent frequency domain resources over the adjacent operating carriers from being used respectively in the same sub-frame, thus avoiding interference between the neighbor cells over the adjacent carriers from arising in the same sub-frame configured with uplink and downlink transmissions.

The frequency domain resources are typically provided with PRBs or PRB identifiers, and in this embodiment, the frequency domain resource use information in the same sub-frame can be PRB occupancy information, or occupancy information of a group of PRBs consists of a plurality of PRBs, in the same sub-frame, thus the neighbor cells use the same PRB or group of PRBs in the same sub-frame configured with uplink and downlink transmissions.

By way of an example, if neighbor cells A and B are configured with data transmissions in different directions in the same sub-frame, specifically, if a cell base station A uses a sub-frame n as a downlink sub-frame, and the neighbor cell base station B uses the sub-frame as an uplink sub-frame, then the cell base station A needs to notify the cell base station B of frequency domain resources to be used for downlink transmission in the sub-frame per PRB or group of PRBs, and also the cell base station B needs to notify the cell base station A of frequency domain resources to be used for uplink transmission in the sub-frame per PRB or group of PRBs. If the neighbor cells A and B are cells in a base station, then the base station adjusts the frequency domain resources used by the cell A and the cell B in the sub-frame n, and if they are cells in different base stations, then the different base stations adjust the frequency domain resources used by the cell A and the cell B in the sub-frame n respectively; or a higher-layer network node of the cell base station A and the cell base station B adjusts the cell A and the cell B.

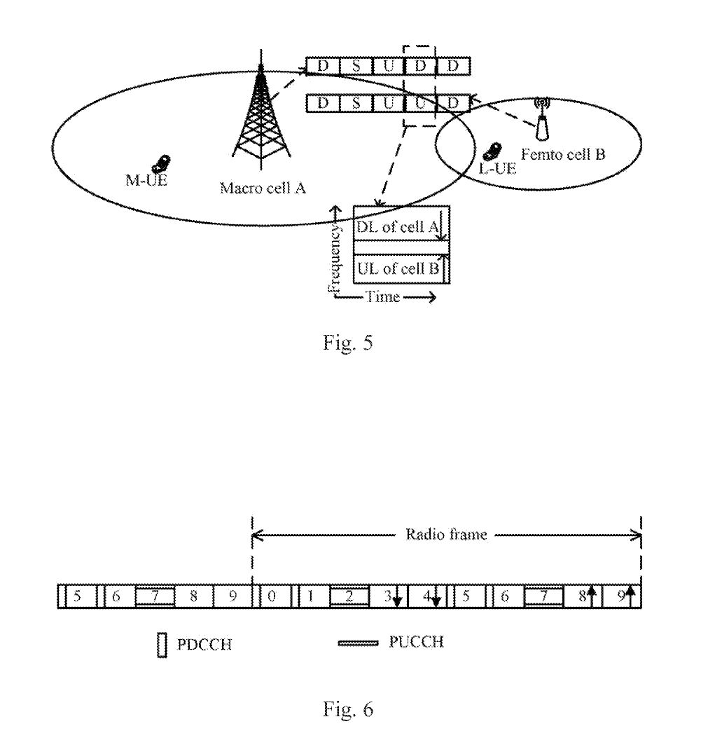

After the frequency domain resources are adjusted, the cell A and the cell B perform data transmissions over different frequency domain resources to avoid cross-timeslot interference. As illustrated in FIG. 5, the cell A is a macro cell in which there is a significant demand for a downlink service, and sub-frames per 5 ms are configured as DSUDD; and the neighbor cell B is a femto cell in which there is a significant demand for an uplink service, and its own sub-frames are configured as DSUUD per 5 ms. In the same sub-frame (the sub-frame 4 as illustrated) in different transmission directions, the two cells transmit data of the respective cells over different frequency domain resources, for example, resources of different PRBs (Physical Resource Blocks) or groups of PRBs.

PRB occupancy conditions can be notified, and preferably in this embodiment, the frequency domain resource use information in the same sub-frame can include a preset number of PRB identifiers as a result of dividing a system bandwidth and their conditions of occupancies by the cells in the same sub-frame. Preferably, the frequency domain resource use information in the same sub-frame can further include any one of identifiers of the cells and transmission directions of the cells in the same sub-frame. As depicted in Table 3-1 and Table 3-2, the frequency domain resource use information in the same sub-frame includes identifiers of the cells, i.e., cell IDs, a preset number of PRB identifiers (e.g., PRB numbers) as a result of dividing a system bandwidth and their conditions of occupancies by the cells in the same sub-frame, and transmission directions of the cells in the same sub-frame. A cell base station is enabled to notify a neighbor cell of frequency domain resources used by a cell in the cell base station in the same sub-frame in the form of a bitmap, as depicted in Table 3-1 and Table 3-2, where there are 110 PRBs in a system bandwidth 20 MHz, and occupancy condition information is notified per PRB. Upon reception of corresponding information sent from the neighbor cell, the cell base station avoids scheduling over a PRB resource, marked by the neighbor cell as occupied, in a sub-frame with different transmission directions.

TABLE 3-1
Cell Base Station Notifies Neighbor Cell of PRB Occupancy
Condition information and Downlink Transmission Direction

| Cell ID | PRB No. | Transmission Direction | Occupied or Unoccupied |
|---|---|---|---|
| A | 0 | Downlink transmission | 1(Occupied) |
| | 1 | | 1 |
| | 2 | | 1 |
| | 3 | | 0 |
| | . . . | | . . . |
| | 110 | | 0(Unoccupied) |

TABLE 3-2
Cell Base Station Notifies Neighbor Cell of PRB Occupancy
Condition information and Uplink Transmission Direction

| Cell ID | PRB No. | Transmission Direction | Occupied or Unoccupied |
|---|---|---|---|
| B | 0 | Uplink transmission | 0 |
| | 1 | | 0 |
| | 2 | | 0 |
| | 3 | | 1 |
| | . . . | | . . . |
| | 110 | | 1 |

In another embodiment of the invention, the data transmission related information obtained by the base station is transmission power information and/or interference level information. The data transmission related information of the neighbor cells in the same sub-frame can include transmission power information of a cell, configured with downlink transmission in the same sub-frame among the neighbor cells, over frequency domain resources in the same sub-frame; and/or interference level information of a cell, configured with uplink transmission in the same sub-frame among the neighbor cells, over frequency domain resources in the same sub-frame. Then interference coordination between the neighbor cells is performed by performing interference coordination between the cell and the neighbor cell through frequency domain resource coordination according to the obtained transmission power information and/or interference level information.

There are three scenarios involved in this embodiment:

1) For the neighbor cells configured with different transmission directions in the same sub-frame, transmission power information of a cell, configured with downlink transmission in the same sub-frame, over frequency domain resources in the same sub-frame needs to be obtained;

2) For the neighbor cells configured with different transmission directions in the same sub-frame, interference level information of a cell, configured with uplink transmission in the same sub-frame, over frequency domain resources in the same sub-frame needs to be obtained; and

3) For the neighbor cells configured with different transmission directions in the same sub-frame, both transmission power information of a cell, configured with downlink transmission in the same sub-frame, over frequency domain resources in the same sub-frame and interference level information of a cell, configured with uplink transmission in the same sub-frame, over frequency domain resources in the same sub-frame need to be obtained.

Preferably, when the transmission power information is obtained, inter-cell interference coordination is performed in the following scheme: 1) frequency domain resources, of a cell configured with downlink transmission in the same sub-frame, with transmission powers exceeding a preset power threshold in the same sub-frame are determined, and frequency domain resources, used by a cell configured with uplink transmission in the same sub-frame, in the same sub-frame are adjusted to avoid using the frequency domain resources with transmission powers exceeding the preset power threshold. Specifically, frequency domain resources, used by a cell configured with uplink transmission, in the same sub-frame are adjusted to avoid all of users from using frequency domain resources with transmission powers exceeding the preset power threshold, or frequency domain resources, used by a cell configured with uplink transmission, in the same sub-frame are adjusted to avoid cell edge users from using frequency domain resources with transmission powers exceeding the preset power threshold.

Preferably, when the interference level information is obtained, the base station performs inter-cell interference coordination in the following scheme: 2) frequency domain resources, of a cell configured with uplink transmission, with interference levels exceeding a preset interference threshold in the same sub-frame are determined, and frequency domain resources, used by a cell configured with downlink transmission, in the same sub-frame are adjusted to avoid using the frequency domain resources with interference levels exceeding the preset interference threshold.

Alternatively, when the interference level information is obtained, the base station performs inter-cell interference coordination in the following scheme: 3) frequency domain resources, of a cell configured with uplink transmission, with interference levels exceeding a preset interference threshold in the same sub-frame are determined, and transmission powers of a cell configured with downlink transmission over frequency domain resources with interference levels exceeding the preset interference threshold in the same sub-frame is lowered.

Thus the interference coordination scheme 1) is adopted for the scenario 1), the interference coordination scheme 2) or the interference coordination scheme 3) can be adopted for the scenario 2), and the interference coordination schemes 1) and 2) or the interference coordination schemes 1) and 3) can be adopted for the scenario 3).

If the executor is a base station, then the neighbor cells are located in the same base station or different base stations, and in the latter case, the neighbor cells perform interaction of transmission power information and/or interference level information in the same sub-frame through signalling interaction between the different base stations.

Preferably, the transmission power information of the frequency domain resources in the same sub-frame configured with the different transmission directions in the neighbor cells can be quantification levels corresponding to transmission powers of respective PRBs used in the same sub-frame, where a different transmission power is quantified into a different level according to a segment of power data to which it belongs.

Preferably, the interference level information of the frequency domain resources in the same sub-frame configured with the different transmission directions in the neighbor cells can be quantification levels corresponding to interference levels of respective PRBs used in the same sub-frame, where a different interference level is quantified into a different level according to a segment of interference data to which it belongs.

In this embodiment, the transmission power information over the frequency domain resources in the same sub-frame includes identifiers of the cells, identifiers of a preset number of PRBs as a result of dividing a system bandwidth and the quantification levels corresponding to their transmission powers in the same sub-frame, and transmission directions of the cells in the same sub-frame; and the interference level information over the frequency domain resources in the same sub-frame includes identifiers of the cells, identifiers of a preset number of PRBs as a result of dividing the system bandwidth and the quantification levels corresponding to their interference levels in the same sub-frame, and transmission directions of the cells in the same sub-frame.

As depicted in Table 4-1 and Table 4-2, the transmission powers/interference levels, etc., can be quantified variously. Assumed there are 110 PRBs in a system bandwidth 20 MHz, and in the case that the neighbor cells are located in different base stations, a base station where a cell with downlink transmission in the same sub-frame is located notifies a base station, where a neighbor cell is located, of transmission power information of the cell in the same sub-frame, and the base station where the cell with uplink transmission in the same sub-frame is located notifies the base station, where the neighbor cell is located, of interference level information of the cell in the same sub-frame. As depicted in Table 4-1 and Table 4-2, the base station where the cell A is located quantifies transmission power information of the cell A for downlink transmission over respective PRBs in a specific sub-frame (which is the same sub-frame configured with different transmission directions) into several levels and notifies the neighbor cell, and upon reception of the information, the base station where the cell B for uplink transmission in the same sub-frame neighbor to the cell A is located avoids uplink transmission from being scheduled over frequency domain resources marked as “High power” or “Medium power” by the base station where the cell A is located; and correspondingly, the base station where the cell B is located quantifies receiving interference level information thereof for uplink transmission over respective PRBs in a specific sub-frame and notifies the base station where the neighbor cell A is located, and upon reception of the information, the base station where the cell A for downlink transmission in the same sub-frame is located avoids downlink transmission from being scheduled, or performs downlink transmission at a low power, over frequency domain resources marked as “High interference level” by the base station where the cell B is located. In Table 4-1, the quantification levels “High power”, “Medium power” and “Low power” correspond to different segments of power data, and “Unused” represents that the PRB is not used; and in Table 4-2, the quantification levels “Low Interference Level” and “High Interference Level” correspond to different segments of interference data.

TABLE 4-1
Cell Base station Notifies Neighbor Cell
of Transmission Power Information

| Cell ID | PRB No. | Transmission Direction | Power Level Information |
|---|---|---|---|
| A | 0 | Downlink transmission | High power |
| | 1 | | High power |
| | 2 | | Medium power |
| | 3 | | Low power |
| | . . . | | . . . |
| | 110 | | Unused |

TABLE 4-2
Cell Base station Notifies Neighbor Cell of
Receiving Interference Level Information

| | | | Interference Level |
|---|---|---|---|
| Cell ID | PRB No. | Transmission Direction | Information |
| B | 0 | Uplink transmission | Low Interference Level |
| | 1 | | Low Interference Level |
| | 2 | | Low Interference Level |
| | 3 | | High Interference Level |
| | . . . | | . . . |
| | 110 | | High Interference Level |

With an application of the method for inter-cell interference coordination according to the embodiment of the invention, transmissions can be performed in neighbor TDD base station cells over the same time resource in different directions, and mutual interference can be avoided through frequency domain resource coordination; and such a situation in the traditional TDD interference coordination method can be obviated that different cells are forced to use the same sub-frame configuration so that service demands of the respective cells can not be accommodated. The technical solution according to the embodiment of the invention can be applicable to such situations that neighbor TDD cells operate over the same operating carriers as well as adjacent operating carriers to avoid effectively cross-timeslot interference at adjacent frequencies due to power leakage.

The method for inter-cell interference coordination according to the embodiment of the invention is applicable to a scenario with a dynamic uplink and downlink sub-frame configuration, e.g. a scenario with the following dynamic allocation scheme.

In a specific time cycle, there are preset four types of sub-frames including sub-frames fixedly used for downlink transmission, sub-frames fixedly used for uplink transmission, and sub-frames flexibly allocated for uplink or downlink transmission. Taking FIG. 6 as an example, the time cycle is one radio frame (which is only illustrative but can alternatively be another time cycle) including the sub-frames #0 and #5 which are fixed downlink sub-frames, the sub-frames #2 and #7 which are fixed uplink sub-frames, the sub-frames #1 and #6 which are special sub-frames (which can also be deemed as fixed downlink sub-frames), and the other sub-frames (#3, #4, #8, #9) which are sub-frames flexibly allocated for uplink or downlink transmission. For the last type of sub-frames, the base station can configure them dynamically dependent on a real-time service demand and channel condition to accommodate a dynamic change in a service demand.

The data transmission related information in this embodiment is applicable to a sub-frame configured with opposite transmission directions in the neighbor cells in the preset time cycle or all sub-frames each of which is configured with opposite transmission directions in the neighbor cells in the preset time cycle. That is, in the foregoing several notification schemes, the contents of the notification can be notifications for one sub-frame in opposite directions, where there is a set of notification information per sub-frame, or can be only a set of notification information applicable to all the sub-frames in opposite directions. Furthermore, the related signalling notification can be performed via a wired interface, e.g., an X2 interface, an S1 interface, etc., or via an air interface between the base stations.

Based on the same inventive idea, embodiments of the invention further provide a device for inter-cell interference coordination and a base station, and since the device and the base station address the problems under a similar principle to the method for inter-cell interference coordination, reference can be made to the implementation of the method for implementations of the device and the base station, and a repeated description thereof will be omitted here.

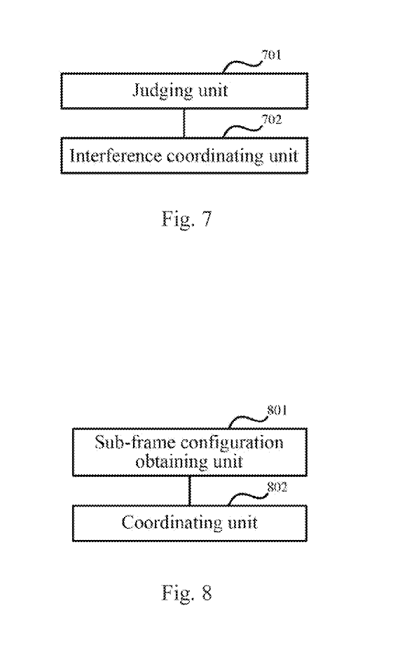

As illustrated in FIG. 7, a device for inter-cell interference coordination according to an embodiment of the invention includes: a judging unit 701 configured to obtain sub-frame configuration information of neighbor cells and to judge whether the neighbor cells are configured with transmissions in different directions in the same sub-frame; and an interference coordinating unit 702 configured to perform interference coordination between the neighbor cells according to obtained data transmission related information if the judgment is positive.

The data transmission related information of the neighbor cells in the same sub-frame includes frequency domain resource use information of the neighbor cells in the same sub-frame; and the interference coordinating unit 702 is configured to perform interference coordination between the neighbor cells through frequency domain resource coordination according to the obtained frequency domain resource use information.

The interference coordinating unit 702 is configured to adjust frequency domain resources used by the neighbor cells in the same sub-frame to avoid the neighbor cells from using the same frequency domain resource in the same sub-frame.

The data transmission related information of the neighbor cells in the same sub-frame includes transmission power information of a cell, configured with downlink transmission in the same sub-frame among the neighbor cells, over frequency domain resources in the same sub-frame; and/or interference level information of a cell, configured with uplink transmission in the same sub-frame among the neighbor cells, over frequency domain resources in the same sub-frame; and the interference coordinating unit 702 is configured to perform interference coordination between the neighbor cells through frequency domain resource coordination according to the obtained transmission power information and/or interference level information.

When the transmission power information is obtained, the interference coordinating unit 702 is configured to determine frequency domain resources, of the cell configured with downlink transmission in the same sub-frame, with transmission powers exceeding a preset power threshold in the same sub-frame, and to adjust the frequency domain resources, used by the cell configured with uplink transmission, in the same sub-frame to avoid using the frequency domain resources with transmission powers exceeding the preset power threshold.

Furthermore, the interference coordinating unit 702 is configured to adjust the frequency domain resources, used by the cell configured with uplink transmission, in the same sub-frame to avoid cell edge users from using the frequency domain resources with transmission powers exceeding the preset power threshold.

When the interference level information is obtained, the interference coordinating unit 702 is configured to determine frequency domain resources, of the cell configured with uplink transmission in the same sub-frame, with interference levels exceeding a preset interference threshold in the same sub-frame, and to adjust frequency domain resources, used by the cell configured with downlink transmission, in the same sub-frame to avoid using the frequency domain resources with interference levels exceeding the preset interference threshold.

Alternatively, when the interference level information is obtained, the interference coordinating unit 702 is configured to determine frequency domain resources, of the cell configured with uplink transmission in the same sub-frame, with interference levels exceeding a preset interference threshold in the same sub-frame, and to lower transmission powers of the cell configured with downlink transmission over the frequency domain resources with interference levels exceeding the preset interference threshold in the same sub-frame.

As illustrated in FIG. 8, a base station according to an embodiment of the invention includes: a sub-frame configuration obtaining unit 801 configured to obtain sub-frame configuration information of neighbor cells; and a coordinating unit 802 configured to adjust a resource used by a cell located in the base station among the neighbor cells to perform interference coordination between the neighbor cells according to obtained data transmission related information of the neighbor cells in the same sub-frame upon determining that the neighbor cells are configured with transmissions in different directions in the same sub-frame. The coordinating unit 802 adjusts the resource used by the cell located in the base station among the neighbor cells as in the foregoing embodiments except that only the cell located in the base station among the neighbor cells is adjusted.

Those skilled in the art shall appreciate that the embodiments of the invention can be embodied as a method, a system or a computer program product. Therefore the invention can be embodied in the form of an all-hardware embodiment, an all-software embodiment or an embodiment of software and hardware in combination. Furthermore, the invention can be embodied in the form of a computer program product embodied in one or more computer useable storage mediums (including but not limited to a disk memory, a CD-ROM, an optical memory, etc.) in which computer useable program codes are contained.

The invention has been described in a flow chart and/or a block diagram of the method, the device (system) and the computer program product according to the embodiments of the invention. It shall be appreciated that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational steps are performed on the computer or the other programmable data processing device to create a computer implemented process so that the instructions executed on the computer or the other programmable data processing device provide steps for performing the functions specified in the flow(s) of the flow chart and/or the block(s) of the block diagram.

Although the preferred embodiments of the invention have been described, those skilled in the art benefiting from the underlying inventive concept can make additional modifications and variations to these embodiments. Therefore the appended claims are intended to be construed as encompassing the preferred embodiments and all the modifications and variations coming into the scope of the invention.

Evidently those skilled in the art can make various modifications and variations to the invention without departing from the scope of the invention. Thus the invention is also intended to encompass these modifications and variations thereto so long as the modifications and variations come into the scope of the claims appended to the invention and their equivalents.

1. A method for inter-cell interference coordination, comprising:
obtaining sub-frame configuration information of neighbor cells and determining whether the neighbor cells are configured with transmissions in different directions in the same sub-frame; and
if so, then performing interference coordination between the neighbor cells according to obtained data transmission related information of the neighbor cells in the same sub-frame.

2. The method according to claim 1, wherein the data transmission related information of the neighbor cells in the same sub-frame comprises:
frequency domain resource use information of the neighbor cells in the same sub-frame;
and wherein performing interference coordination between the neighbor cells comprises:
performing interference coordination between the neighbor cells through frequency domain resource coordination according to the obtained frequency domain resource use information.

3. The method according to claim 2, wherein performing interference coordination between the neighbor cells through frequency domain resource coordination comprises:
adjusting frequency domain resources used by the neighbor cells in the same sub-frame to avoid the neighbor cells from using the same frequency domain resource in the same sub-frame.

4. (canceled)

5. The method according to claim 2, wherein the frequency domain resource use information in the same sub-frame comprises Physical Resource Block, PRB, occupancy information, or occupancy information of a group of PRBs, which consists of a plurality of PRBs, in the same sub-frame.

6. The method according to claim 5, wherein the frequency domain resource use information in the same sub-frame further comprises:
identifiers of a preset number of PRBs as a result of dividing a system bandwidth and their conditions of occupancies by the cells in the same sub-frame.

7. The method according to claim 6, wherein the frequency domain resource use information in the same sub-frame further comprises any one of identifiers of the cells and transmission directions of the cells in the same sub-frame.

8. The method according to claim 1, wherein the data transmission related information of the neighbor cells in the same sub-frame comprises:
transmission power information of a cell, configured with downlink transmission in the same sub-frame among the neighbor cells, over frequency domain resources in the same sub-frame; and/or
interference level information of a cell, configured with uplink transmission in the same sub-frame among the neighbor cells, over frequency domain resources in the same sub-frame;
and wherein performing interference coordination between the neighbor cells comprises:
performing interference coordination between the neighbor cells through frequency domain resource coordination according to the obtained transmission power information and/or interference level information.

9. The method according to claim 8, wherein when the transmission power information is obtained, performing interference coordination between the neighbor cells through frequency domain resource coordination comprises:
determining frequency domain resources, of the cell configured with downlink transmission, with transmission powers exceeding a preset power threshold in the same sub-frame; and
adjusting frequency domain resources, used by the cell configured with uplink transmission, in the same sub-frame to avoid using the frequency domain resources with transmission powers exceeding the preset power threshold.

10. The method according to claim 9, wherein adjusting the frequency domain resources, used by the cell configured with uplink transmission, in the same sub-frame to avoid using the frequency domain resources with transmission powers exceeding the preset power threshold comprises:
adjusting the frequency domain resources, used by the cell configured with uplink transmission, in the same sub-frame to avoid cell edge users from using the frequency domain resources with transmission powers exceeding the preset power threshold.

11. The method according to claim 8, wherein when the interference level information is obtained, performing interference coordination between the neighbor cells through frequency domain resource coordination comprises:
determining frequency domain resources, of the cell configured with uplink transmission, with interference levels exceeding a preset interference threshold in the same sub-frame, and
adjusting the frequency domain resources, used by the cell configured with downlink transmission, in the same sub-frame to avoid using the frequency domain resources with interference levels exceeding the preset interference threshold.

12. The method according to claim 8, wherein when the interference level information is obtained, performing interference coordination between the neighbor cells through frequency domain resource coordination comprises:
determining frequency domain resources, of the cell configured with uplink transmission, with interference levels exceeding a preset interference threshold in the same sub-frame, and
lowering transmission powers of the cell configured with downlink transmission over the frequency domain resources with interference levels exceeding the preset interference threshold in the same sub-frame.

13. (canceled)

14. The method according to claim 8, wherein the transmission power information over the frequency domain resources in the same sub-frame comprises quantification levels corresponding to transmission powers of respective Physical Resource Blocks, PRBs, used in the same sub-frame, wherein a different transmission power is quantified into a different level according to a segment of power data to which it belongs; and
the interference level information over the frequency domain resources in the same sub-frame comprises quantification levels corresponding to interference levels of respective PRBs used in the same sub-frame, wherein a different interference level is quantified into a different level according to a segment of interference data to which it belongs.

15. The method according to claim 14, wherein the transmission power information over the frequency domain resources in the same sub-frame further comprises:
Identifiers of a preset number of PRBs as a result of dividing a system bandwidth and the quantification levels corresponding to their transmission powers in the same sub-frame;
and wherein the interference level information over the frequency domain resources in the same sub-frame further comprises:
identifiers of a preset number of PRBs as a result of dividing the system bandwidth and the quantification levels corresponding to their interference levels in the same sub-frame.

16. The method according to claim 15, wherein the transmission power information over the frequency domain resources in the same sub-frame further comprises any one of identifiers of the cells and transmission directions of the cells in the same sub-frame; and
the interference level information over the frequency domain resources in the same sub-frame further comprises any one of identifiers of the cells and transmission directions of the cells in the same sub-frame.

17. (canceled)

18. The method according to claim 1, wherein an executor for inter-cell interference coordination is a base station or a higher-layer network node of a base station, and when the executor is a base station, the base station adjusts a resource used by a cell located in the base station among the neighbor cells to perform interference coordination between the neighbor cells.

19. A device for inter-cell interference coordination, comprising:
a judging unit configured to obtain sub-frame configuration information of neighbor cells and to judge whether the neighbor cells are configured with transmissions in different directions in the same sub-frame; and
an interference coordinating unit configured to perform interference coordination between the neighbor cells according to obtained data transmission related information if the judgment is positive.

20. The device according to claim 19, wherein the data transmission related information of the neighbor cells in the same sub-frame comprises frequency domain resource use information of the neighbor cells in the same sub-frame; and the interference coordinating unit is configured to perform interference coordination between the neighbor cells through frequency domain resource coordination according to the obtained frequency domain resource use information.

21. The device according to claim 20, wherein the interference coordinating unit is configured to adjust frequency domain resources used by the neighbor cells in the same sub-frame to avoid the neighbor cells from using the same frequency domain resource in the same sub-frame.

22. The device according to claim 19, wherein the data transmission related information of the neighbor cells in the same sub-frame comprises transmission power information of a cell, configured with downlink transmission in the same sub-frame among the neighbor cells, over frequency domain resources in the same sub-frame; and/or interference level information of a cell, configured with uplink transmission in the same sub-frame among the neighbor cells, over frequency domain resources in the same sub-frame; and
the interference coordinating unit is configured to perform interference coordination between the neighbor cells through frequency domain resource coordination according to the obtained transmission power information and/or interference level information.

23-26. (canceled)

27. A base station, comprising:
a sub-frame configuration obtaining unit configured to obtain sub-frame configuration information of neighbor cells; and
a coordinating unit configured to adjust a resource used by a cell located in the base station among the neighbor cells to perform interference coordination between the neighbor cells according to obtained data transmission related information of the neighbor cells in the same sub-frame upon determining that the neighbor cells are configured with transmissions in different directions in the same sub-frame.
